(19) United States
(12) Patent Application Publication
(10) Pub. No.: US 2025/0108858 A1
(43) Pub. Date: Apr. 3, 2025

(54) REAR WHEEL STEERING APPARATUS

(71) Applicant: AISIN CORPORATION, Kariya (JP)

(72) Inventors: Akira TAKAHASHI, Kariya-shi (JP); Kazuki Sugimori, Kariya-shi (JP); Takeru Tsuji, Kariya-shi (JP); Toshihisa Habiro, Kariya-shi (JP)

(73) Assignee: AISIN CORPORATION, Kariya (JP)

(21) Appl. No.: 18/828,176

(22) Filed: Sep. 9, 2024

(30) Foreign Application Priority Data
Sep. 29, 2023 (JP) 2023-169578

(51) Int. Cl. B62D 6/00; B62D 5/04

(52) U.S. Cl. CPC B62D 6/002; B62D 5/046

(57) ABSTRACT

A rear wheel steering apparatus includes: a rear wheel steering mechanism configured to set a control speed of a rear wheel steering actuator in accordance with a vehicle speed of a vehicle; an acquisition unit configured to acquire traveling operation input information of the vehicle; a correction unit configured to correct the control speed based on the traveling operation input information; and a drive control unit configured to drive the rear wheel steering actuator based on a correction result of correction by the correction unit obtained by switching between a case where the control speed is limited and a case where the control speed is not limited.

### CROSS REFERENCE TO RELATED APPLICATIONS

This application is based on and claims priority under 35 U.S.C. § 119 to Japanese Patent Application 2023-169578, filed on Sep. 29, 2023, the entire content of which is incorporated herein by reference.

### TECHNICAL FIELD

This disclosure relates to a rear wheel steering apparatus.

### BACKGROUND DISCUSSION

In the related art, a vehicle that allows rear wheel steering performed by a rear wheel steering apparatus in addition to front wheel steering performed by a front wheel steering apparatus is put into practical use. The rear wheel steering apparatus can steer a rear wheel in accordance with a steering angle of a front wheel, for example, by an actuator including a motor, a planetary gear, and the like, and the front wheel and the rear wheel are steered in a same phase or in opposite phases in accordance with a traveling state of the vehicle. Steering the rear wheel in addition to the front wheel can contribute to stabilizing a traveling posture and improving turning performance.

Examples of the related art include JP 6945799B (Reference 1) and JP 2019-214311A (Reference 2).

In the rear wheel steering apparatus, as a control speed of the actuator is increased, rear wheel steering performance can be improved and high response performance can be obtained. On the other hand, when the control speed is increased, an operation noise becomes larger, which may cause a decrease in quietness of the vehicle, and may make a passenger feel uncomfortable. That is, in the rear wheel steering apparatus, when a control is performed to slow down the control speed with an emphasis on reducing operating noise, sufficient response performance may not be obtained. In addition, when a control is performed to increase the control speed with an emphasis on responsiveness, there is a problem that the quietness may be insufficient and the passenger may feel uncomfortable.

A need thus exists for a rear wheel steering apparatus which is not susceptible to the drawback mentioned above.

### SUMMARY

A rear wheel steering apparatus according to an aspect of this disclosure includes: a rear wheel steering mechanism configured to set a control speed of a rear wheel steering actuator in accordance with a vehicle speed of a vehicle; an acquisition unit configured to acquire traveling operation input information of the vehicle; a correction unit configured to correct the control speed based on the traveling operation input information; and a drive control unit configured to drive the rear wheel steering actuator based on a correction result of correction by the correction unit obtained by switching between a case where the control speed is limited and a case where the control speed is not limited.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exemplary and schematic diagram illustrating a vehicle including a rear wheel steering apparatus according to an embodiment;

FIG. 2 is an exemplary and schematic block diagram illustrating a configuration of the rear wheel steering apparatus according to the embodiment;

FIG. 3 is an exemplary and schematic control map illustrating relation between a control speed and a vehicle speed at the time when emphasis is placed on prevention of operation noise and when emphasis is placed on performance in the rear wheel steering apparatus according to the embodiment;

FIG. 4 is an exemplary and schematic diagram illustrating a procedure of adjusting a limit on a control speed of rear wheel steering in response to a driver input and calculation of a target rear wheel angle after adjusting the limit in the rear wheel steering apparatus according to the embodiment; and

FIG. 5 is an exemplary and schematic diagram illustrating a holding function of the rear wheel steering at the time when slalom traveling is performed in the rear wheel steering apparatus according to the embodiment.

### DETAILED DESCRIPTION

Hereinafter, embodiments and modifications disclosed here will be described with reference to drawings. Configurations of the embodiments and modifications described below, as well as operational effects brought about by the configurations, are merely examples, and are not limited to the following description.

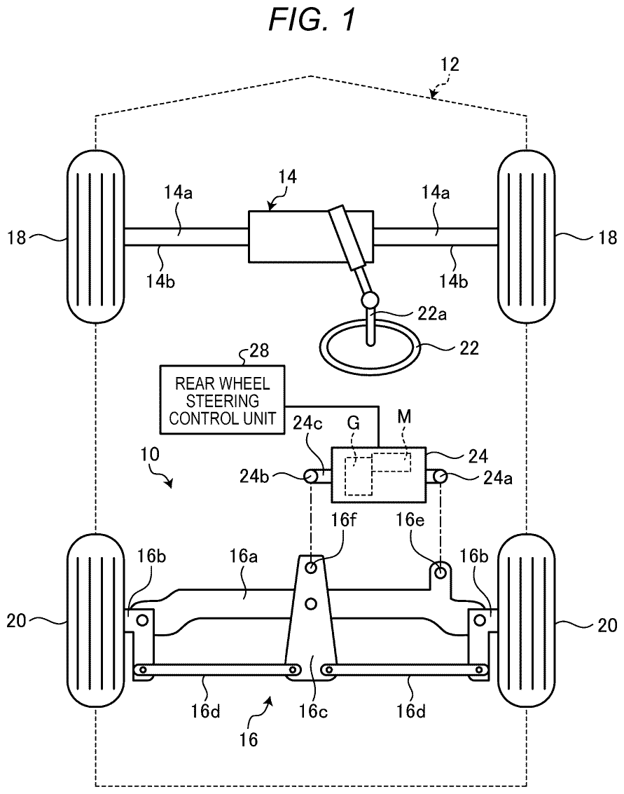

FIG. 1 is an exemplary and schematic diagram illustrating a vehicle 12 including a rear wheel steering apparatus 10 according to an embodiment.

The vehicle 12 includes a four wheel steering system including a front wheel steering mechanism 14 and a rear wheel steering mechanism 16. A pair of left and right front wheels 18 can be steered by the front wheel steering mechanism 14. A pair of left and right rear wheels 20 can be steered by the rear wheel steering mechanism 16.

The front wheel 18 is steered by a movement of a steering rod 14a corresponding to a steering angle of a steering wheel 22. A rotation of the steering wheel 22 steered by a driver is transmitted to the front wheel steering mechanism 14 via a steering column 22a, and the steering rod 14a linearly moves in an axial direction. This linear movement is transmitted via a tie rod 14b, causing the orientation of the front wheel 18 to change in conjunction. The steering column 22a that rotates integrally with the steering wheel 22 is provided with a steering angle sensor.

The rear wheel steering mechanism 16 is attached across a wheel-side member and a vehicle body-side member of a suspension mechanism that supports the left and right rear wheels 20. Left and right wheel supports 16b are swingably connected to a cross member 16a on the vehicle body side. The left and right wheel supports 16b are connected to a steering link 16c, which is swingably provided on the cross member 16a, via left and right tie rods 16d, respectively. The rear wheel steering mechanism 16 is driven by a rear wheel steering actuator 24 provided in the rear wheel steering apparatus 10. Regarding a first coupling unit 24a and a second coupling unit 24b provided on both ends of the rear wheel steering actuator 24, the first coupling unit 24a is coupled to a first coupled unit 16e that is a part of the cross member 16a, and the second coupling unit 24b is coupled to a second coupled unit 16f that is one end of the steering link 16c. The rear wheel 20 is steered by swinging the steering link 16c by extension and contraction of a rod 24c that is integrally formed with the second coupling unit 24b of the rear wheel steering actuator 24. The rod 24c extends and contracts with respect to the rear wheel steering actuator 24 by being linearly moved by, for example, a motor M and a planetary gear G constituting the rear wheel steering actuator 24. The rear wheel steering mechanism 16 can steer the rear wheel 20 in a same phase or in opposite phases with respect to the front wheel 18 in accordance with a traveling state of the vehicle 12. A response speed of the rear wheel steering mechanism 16 can be controlled by controlling a driving speed of the motor M. The vehicle 12 includes the front wheel steering mechanism 14 and the rear wheel steering mechanism 16, and therefore, a traveling posture can be stabilized, and turning performance can be improved as compared with a vehicle including only the front wheel steering mechanism 14.

In the rear wheel steering mechanism 16 configured as described above, as a control speed of the rear wheel steering actuator 24 is increased, rear wheel steering performance can be improved and high response performance can be obtained. On the other hand, when the control speed of the rear wheel steering actuator 24 is increased, an operation noise, for example, a gear rattle noise of a planetary gear becomes larger, which may cause a decrease in quietness of the vehicle 12, and may make a passenger feel uncomfortable. Generally, when the vehicle 12 travels at a low speed, a steering amount of the rear wheel 20 tends to be larger, and an operation noise of the rear wheel steering actuator 24 becomes more noticeable. Conversely, when the vehicle 12 travels at a high speed, the steering amount of the rear wheel 20 tends to be smaller, a road noise tends to be larger, and the operation noise of the rear wheel steering actuator 24 becomes less noticeable. Therefore, when the vehicle 12 travels at a low speed at which the noise such as the road noise is less likely to be generated, a control may be performed to limit the control speed of the rear wheel steering actuator 24 to prevent the generation of the operation noise with an emphasis on the quietness. On the other hand, when the vehicle 12 travels at a high speed at which the noise such as the road noise is likely to be generated, even if the operation noise of the rear wheel steering actuator 24 is generated, the operation noise becomes less noticeable due to the noise such as the road noise. Therefore, a control may be performed to release a limit on the control speed of the rear wheel steering actuator 24 with an emphasis on the response performance of the rear wheel steering performance.

However, when the control speed is uniformly limited for each vehicle speed as described above, the performance may not be satisfied depending on an operation input for driving performed by the driver in low and medium speed ranges. For example, the steering wheel 22 may be quickly steered to a neutral position when the vehicle 12 is returned to straight traveling from right or left turn at an intersection. In this case, the front wheel steering mechanism 14 directly coupled to the steering wheel 22 moves the front wheel 18 in substantially the same phase, but the rear wheel steering mechanism 16 is driven by a staggered wire, and therefore, the steering of the rear wheel 20 is delayed. As a result, the steering wheel may be off-center for a certain time. In this case, as the rear wheel 20 is steered, a self-aligning torque acts on the front wheel 18, the front wheel 18 is steered by the same amount in an attempt to go straight, but this may result in a so-called crab-like movement and the occurrence of swerving.

Even during slalom traveling in which the steering wheel 22 is steered quickly, a delay in a steering angle (rear wheel angle) of the rear wheel 20 occurs with respect to a steering angle (front wheel angle) of the front wheel 18. As a result, a delay in a yaw rate may occur, and an error may occur with respect to an ideal traveling line.

Therefore, the rear wheel steering apparatus 10 according to the embodiment disclosed here is not one that controls the rear wheel steering mechanism 16 only in accordance with the vehicle speed, but is one that controls the rear wheel steering mechanism 16 also taking into account traveling operation input information of the vehicle 12. That is, the above problem is solved by correcting the control speed of the rear wheel steering actuator 24 in consideration of a driving operation condition of the driver.

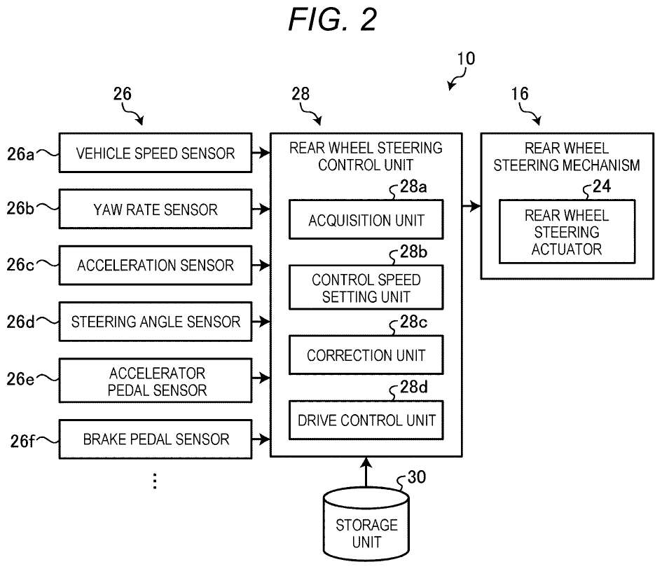

FIG. 2 is an exemplary and schematic block diagram illustrating a configuration of the rear wheel steering apparatus 10. The rear wheel steering apparatus 10 includes a rear wheel steering control unit 28, a storage unit 30, and the like in addition to the above rear wheel steering mechanism 16. The rear wheel steering control unit 28 controls the rear wheel steering mechanism 16 based on a detection result of various sensors 26 mounted on the vehicle 12. The storage unit 30 stores a map or the like that is referred to when the rear wheel steering control unit 28 sets the control speed of the rear wheel steering actuator 24. Examples of the map include a map that defines relation between the control speed of the rear wheel steering actuator 24 and the vehicle speed, a map that defines relation between the control speed of the rear wheel steering actuator 24 and a steering speed of the steering wheel 22, a map that defines relation between the control speed of the rear wheel steering actuator 24 and acceleration or deceleration of the vehicle 12, and a map that defines relation with the control speed of the rear wheel steering actuator 24 at the time when the steering wheel 22 is returned to a neutral direction. These maps can be determined by a test or the like in advance. The above maps are examples, and the storage unit 30 may store a map indicating a correspondence with other traveling operation input information.

The various sensors 26 supply, to the rear wheel steering control unit 28, traveling operation input information indicating the driving operation condition of the driver. A vehicle speed sensor 26a detects a rotation amount or a rotation speed per unit time by, for example, a Hall element provided in the vicinity of the front wheel 18 or the rear wheel 20, and outputs the vehicle speed. A yaw rate sensor 26b detects a yaw rate (a change speed of a rotation angle in a yaw direction (a turning direction)) of the vehicle 12. An acceleration sensor 26c detects the acceleration in a longitudinal direction or a lateral direction of the vehicle 12. A steering angle sensor 26d is, for example, a sensor that detects a steering amount of the steering wheel 22, and is implemented by, for example, the Hall element. Information regarding a steering direction and a steering speed of the steering wheel 22 can also be acquired based on a signal output from the steering angle sensor 26d. An accelerator pedal sensor 26e outputs information regarding a depression amount and a depression speed of an accelerator pedal, and can be used to detect quick acceleration of the vehicle 12. A brake pedal sensor 26f outputs information regarding a depression amount and a depression speed of a brake pedal, and can be used to detect quick deceleration of the vehicle 12. The sensors 26 illustrated in FIG. 2 are examples, and may be a sensor that outputs the traveling operation input information indicating the driving operation condition of the driver, and output results may be sequentially provided to the rear wheel steering control unit 28.

The rear wheel steering control unit 28 includes an acquisition unit 28a, a control speed setting unit 28b, a correction unit 28c, a drive control unit 28d, and the like.

The acquisition unit 28a acquires the detection result of the various sensors 26, that is, the traveling operation input information of the vehicle 12. The acquisition unit 28a acquires, as the traveling operation input information, for example, steering speed information of front wheel steering of the vehicle 12 from the steering angle sensor 26d. The acquisition unit 28a acquires, as the traveling operation input information, acceleration or deceleration information of the vehicle 12 from the acceleration sensor 26c, the accelerator pedal sensor 26e, the brake pedal sensor 26f, and the like. The acquisition unit 28a acquires, as the traveling operation input information, the steering direction information of the front wheel steering of the vehicle 12 from the steering angle sensor 26d, the yaw rate sensor 26b, and the like. In addition, the acquisition unit 28a acquires, as the traveling operation input information, reverse operation information indicating that a reverse operation of the front wheel steering of the vehicle 12 is performed at a predetermined speed or higher, that is, the slalom traveling is performed, from the steering angle sensor 26d, the yaw rate sensor 26b, and the like.

The control speed setting unit 28b can set a control speed serving as a basis of the control speed (basic control speed) of the rear wheel steering actuator 24 based on the vehicle speed of the vehicle 12 acquired from the vehicle speed sensor 26a with reference to a map stored in the storage unit 30. The map defines the relation between the control speed of the rear wheel steering actuator 24 and the vehicle speed.

The correction unit 28c corrects, based on the traveling operation input information from the various sensors 26 acquired by the acquisition unit 28a, the basic control speed of the rear wheel steering actuator 24 set in accordance with the vehicle speed by the control speed setting unit 28b. The details of the correction performed by the correction unit 28c will be described later.

The drive control unit 28d performs switching (distinction), based on a correction result of the correction unit 28c, between an operation noise prevention priority control that limits the control speed of the rear wheel steering actuator 24 and a performance priority control that does not limit the control speed, generates a drive command for driving the rear wheel steering actuator 24, and outputs the drive command to the rear wheel steering actuator 24.

In the switching between the operation noise prevention priority control and the performance priority control, the correction unit 28c may generate a switching signal for instructing the switching between the operation noise prevention priority control and the performance priority control and supply the switching signal to the drive control unit 28d, and the drive control unit 28d may perform switching processing based on the switching signal. In another embodiment, the drive control unit 28d may acquire, from the correction unit 28c, the correction result (a correction content), for example, correction information necessary for switching the control that is acquired with reference to various control maps stored in the storage unit 30, and the drive control unit 28d may generate the switching signal based on the correction information and perform switching between the operation noise prevention priority control and the performance priority control. In the following description, an example is illustrated in which the correction unit 28c generates the switching signal instructing the switching between the operation noise prevention priority control and the performance priority control, and the drive control unit 28d performs control switching processing of the rear wheel steering actuator 24 based on the switching signal.

A rear wheel steering control performed by the rear wheel steering apparatus 10 configured as described above will be described in detail. For example, uncomfortable feeling such as swerving at the time when the vehicle 12 is returned to the straight traveling from the right or left turn at the intersection becomes apparent when a control for the rear wheel 20 is delayed with respect to an input of the steering wheel 22. That is, the quicker the steering of the steering wheel 22 is, the more likely the uncomfortable feeling is generated. On the other hand, in a scene in which the steering is quick, it can be considered that the driver operates the steering wheel 22 quickly and the behavior of the vehicle 12 also changes rapidly. In such a case, it can be said that the operation noise of the rear wheel steering actuator 24 is less likely to be recognized by the driver even in a situation where the vehicle speed is low. That is, it can be considered that the operation noise is less noticeable.

Therefore, the correction unit 28c corrects, based on the traveling operation input information (driving operation condition of the driver) of the vehicle 12, the control speed (basic control speed) determined by the control speed setting unit 28b based on the vehicle speed. The correction unit 28c corrects the control speed of the rear wheel steering actuator 24 based on, for example, the steering speed of the steering wheel 22, the acceleration or deceleration of the vehicle 12, and whether the steering direction of the steering wheel 22 is a neutral return direction or a non-neutral direction (turn-increasing direction), and implements the correction by the operation noise prevention priority control that limits the control speed of the rear wheel steering actuator 24 or the performance priority control that does not limit the control speed. In other words, in a situation in which the performance is desired to be emphasized (a situation in which the noise is less noticeable), even when the vehicle speed is low, the limit on the control speed is temporarily relaxed (the generation of the operation noise is allowed in a situation in which the noise is less noticeable), thereby improving the performance of the vehicle 12 while taking measures against the operation noise.

An individual example of the correction performed by the correction unit 28c will be specifically described. First, a correction according to the steering speed of the steering wheel 22 will be described. The rear wheel steering control unit 28 basically controls the rear wheel steering actuator 24 at the control speed according to the vehicle speed set by the control speed setting unit 28b, and further adjusts (corrects) the limit on the control speed of the rear wheel steering actuator 24 in accordance with the steering speed of the steering wheel 22. That is, when the steering wheel 22 is moved quickly, the correction unit 28c generates a switching signal for switching to a control for prioritizing the behavior of the vehicle 12, and releases the limit on the control speed of the rear wheel steering actuator 24. That is, the generation of the operation noise is allowed, but in a scene in which the steering wheel 22 is quickly moved, since the vehicle 12 also moves significantly, the operation noise becomes less noticeable, and therefore, the performance priority control for prioritizing the response performance of the vehicle 12 is performed. That is, the response performance of the vehicle 12 can be acquired, and the uncomfortable feeling due to the operation noise can be reduced. On the other hand, when the steering wheel 22 is slowly operated, the behavior of the vehicle 12 also changes slowly, and the operation noise at the time when the rear wheel steering actuator 24 is operated becomes more noticeable. Therefore, when the steering wheel 22 is slowly operated, the correction unit 28c generates a switching signal for switching to a control for prioritizing the reduction of the operation noise, limits the control speed of the rear wheel steering actuator 24 in accordance with an operation speed of the steering wheel 22 and the vehicle speed, and executes the operation noise prevention priority control. That is, the uncomfortable feeling due to the operation noise can be reduced.

Next, a correction according to the acceleration or deceleration at the time when the vehicle 12 is accelerated or decelerated, for example, when a significant change occurs in the behavior of the vehicle 12 due to an operation of the accelerator pedal or brake pedal, will be described. While the vehicle 12 is traveling, the rear wheel steering control unit 28 basically controls the rear wheel steering actuator 24 at the control speed according to the vehicle speed set by the control speed setting unit 28b, and further adjusts (corrects) the limit on the control speed of the rear wheel steering actuator 24 in accordance with the acceleration or deceleration of the vehicle 12 (operation of the accelerator pedal or brake pedal). That is, when quick acceleration or deceleration is performed, the correction unit 28c generates the switching signal for switching to the control for prioritizing the behavior of the vehicle 12, and releases the limit on the control speed of the rear wheel steering actuator 24. That is, the generation of the operation noise is allowed, but when the quick acceleration or deceleration is performed, the behavior of the vehicle 12 also significantly changes, and therefore, the operation noise becomes less noticeable. Therefore, the performance priority control for prioritizing the response performance of the vehicle 12 is performed. That is, the response performance of the vehicle 12 can be acquired, and the uncomfortable feeling due to the operation noise can be reduced. On the other hand, when the quick acceleration is not performed, the behavior of the vehicle 12 also changes slowly, and the operation noise at the time when the rear wheel steering actuator 24 is operated becomes more noticeable. Therefore, when the quick acceleration is not performed, the correction unit 28c generates the switching signal for switching to the control for prioritizing the reduction of the operation noise, limits the control speed of the rear wheel steering actuator 24 in accordance with the vehicle speed, and executes the operation noise prevention priority control for reducing the operation noise. That is, the uncomfortable feeling due to the operation noise can be reduced.

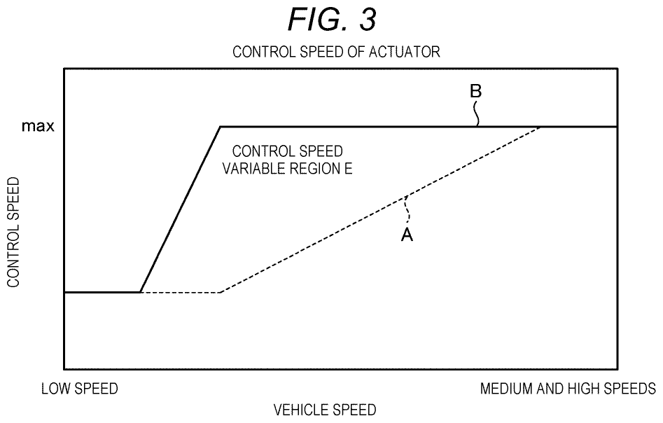

FIG. 3 is an exemplary and schematic control map illustrating relation between the control speed and the vehicle speed at the time when emphasis is placed on prevention of the operation noise and when emphasis is placed on the performance in the rear wheel steering apparatus 10. In FIG. 3, a horizontal axis represents the vehicle speed. A vertical axis represents a control speed serving as a reference of the rear wheel steering actuator 24. A map A indicated by a broken line indicates that the operation noise prevention is emphasized, and when the speed is controlled at or below the map A, the operation noise can be considered to be at an unconcerned level. On the other hand, a map B indicated by a solid line takes into account performance of the vehicle 12, and indicates a control speed of the rear wheel steering actuator 24 that is required when the performance of the vehicle 12 is desired to be sufficiently exhibited. A control speed variable region E between the map A and the map B is a region in which the performance decreases when the operation noise prevention is emphasized, and the generation of the operation noise is concerned when the performance is emphasized. Therefore, in the control speed variable region E, by setting (correcting) the control speed in accordance with a driving manner of the vehicle 12 (traveling operation input information for driving) and the vehicle speed, the rear wheel steering control can be implemented while taking a balance between emphasis on the operation noise prevention of the rear wheel steering actuator 24 and emphasis on the performance of the vehicle 12 as described above. That is, the above operation noise prevention priority control is a control that prioritizes the operation noise prevention while minimizing degradation of the performance, and the performance priority control is a control that prioritizes the performance while minimizing degradation of an operation noise prevention effect.

Next, a correction at the time when the steering wheel 22 is returned to the neutral direction, such as when the vehicle 12 is returned to the straight traveling from the right or left turn at the intersection or when the vehicle 12 is returned to a straight traveling state from a turning state after making a U-turn, will be described. In general, the steering speed of the steering wheel 22 is higher in steering for returning to the neutral direction (steering to a center position) than in steering in a case of turning to make a turn (steering to a non-neutral direction). When the rear wheel steering actuator 24 is limited at the same control speed as the turning of the steering wheel 22 based on the vehicle speed at the time of steering to return to the neutral direction, the control speed is significantly limited. In this case, the front wheel 18 is returned in response to the steering of the steering wheel 22, but the rear wheel 20 is returned with a delay due to speed limitation. In this case, the vehicle 12 attempts to travel straight. That is, the front wheel 18 is desired to return to a straight-ahead position, but since the rear wheel 20 is turned, the front wheel 18 is turned in an opposite direction, causing the vehicle to travel obliquely. Therefore, the correction unit 28c refers to a dedicated map when the steering wheel 22 is returned to the neutral direction. The dedicated map in this case makes it easier for the rear wheel 20 to return to the center when the steering wheel 22 is returned to the neutral direction. That is, when the steering wheel 22 is returned to the neutral direction, the behavior of the vehicle 12 is given priority over turning of the steering wheel 22 (steering to the non-neutral direction), and the correction unit 28c generates a switching signal for switching the control such that the limit on the control speed of the rear wheel steering actuator 24 is released. That is, the performance priority control is performed. For example, a correction control for the control speed is not performed. As a result, the occurrence of swerving (steering wheel off-center), which is likely to occur in the case of returning to the straight traveling from the right or left turn at the intersection, can be prevented. In this case, the generation of the operation noise is allowed, but when the steering wheel 22 is returned to the neutral direction, the steering speed is high and the behavior of the vehicle 12 also significantly changes, and therefore, the operation noise becomes less noticeable. Therefore, the response performance of the vehicle 12 can be acquired, and the uncomfortable feeling due to the operation noise can be reduced. On the other hand, when the steering wheel 22 is turned, the steering speed is slower and the behavior of the vehicle 12 tends to change slowly than when the steering wheel 22 is returned to the neutral direction. That is, the operation noise at the time when the rear wheel steering actuator 24 is operated becomes more noticeable. Therefore, in this case, a switching signal for switching the control is generated such that the control speed of the rear wheel steering actuator 24 is limited in accordance with the vehicle speed. That is, the operation noise prevention priority control for reducing the operation noise is performed. As a result, the uncomfortable feeling due to the operation noise can be reduced.

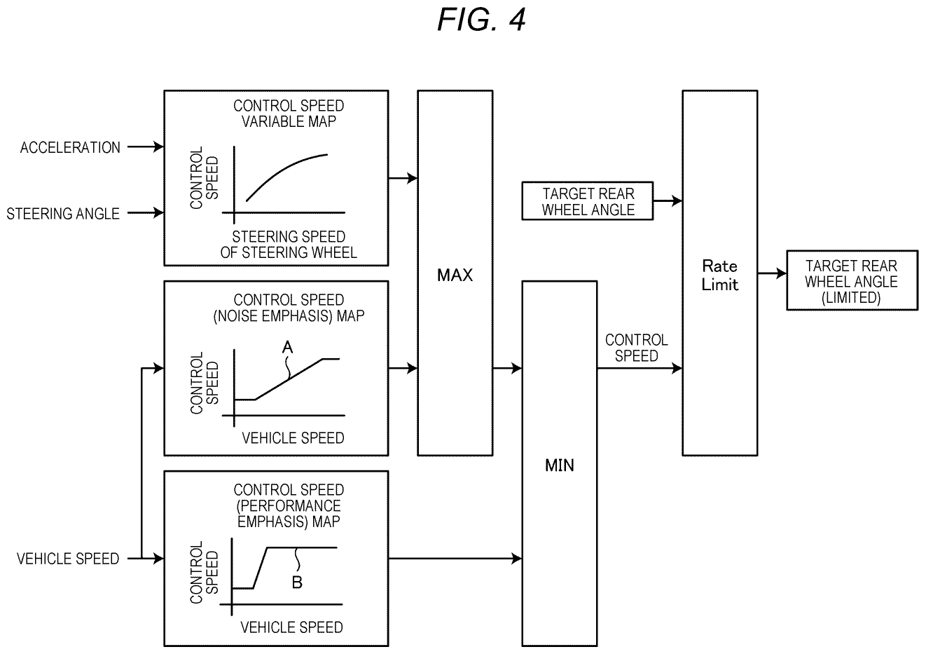

FIG. 4 is a diagram collectively illustrating the above controls, and is an exemplary and schematic diagram illustrating a procedure of adjusting a limit on a control speed of rear wheel steering in response to a driver input and calculation of a target rear wheel angle after adjusting the limit in the rear wheel steering apparatus 10. FIG. 4 illustrates a case where the steering speed information of the front wheel steering (steering wheel 22) of the vehicle 12 is used as the traveling operation input information.

First, in a first step, the rear wheel steering control unit 28 (correction unit 28c) compares a control speed set, based on the vehicle speed of the vehicle 12, in a map in which the operation noise prevention is emphasized (map A in FIG. 3) with a control speed set in a control speed variable map based on a steering angle during traveling, and adopts the larger control speed. For example, when the steering of the steering wheel 22 is quick, the control speed of the rear wheel steering actuator 24 is set to a release side (quick movement side). In the first step, when acceleration information of the vehicle 12 is referred to as the traveling operation input information, the control speed of the rear wheel steering actuator 24 is set to the release side (quick movement side) when the acceleration or deceleration is large. When it is indicated that the steering wheel 22 is steered to the neutral direction as the traveling operation input information, the control speed of the rear wheel steering actuator 24 is set to the quick movement side (release side).

Next, in a second step, the control speed adopted in the first step is compared with a control speed set, based on the vehicle speed of the vehicle 12, in a map in which the performance is emphasized (map B in FIG. 3), and the smaller value is adopted. In this case, when the map B in which the performance is emphasized becomes an upper limit value, but the control speed adopted in the first step is below a line of the map B in which the performance is emphasized, a value acquired in the emphasis on the operation noise prevention adopted in the first step is adopted. Further, when the control speed set, based on the vehicle speed, in the map B in which the performance is emphasized is lower, since this value is the upper limit value, the control speed at the time when the performance is emphasized is adopted. At this stage, a control speed of the rear wheel steering actuator 24 based on current traveling operation input information of the vehicle 12 is determined. That is, the correction unit 28c determines the control speed of the rear wheel steering actuator 24 based on the traveling operation input information, thereby generating information (switching signal) for switching between the operation noise prevention priority control that limits the control speed and the performance priority control that does not limit the control speed.

Then, the rear wheel steering control unit 28 (drive control unit 28d) performs a limit on a change amount (rate limit) based on the control speed (switching signal) determined by the correction unit 28c with respect to a target angle (target rear wheel angle) of the rear wheel 20 that originally attempts to move based on the steering of the steering wheel 22, and calculates a final target rear wheel angle (limited). That is, the rear wheel steering actuator 24 is controlled based on the target rear wheel angle after the limit. As a result, a well-balanced rear wheel steering control can be implemented that can reduce the uncomfortable feeling due to the operation noise felt by the driver (passenger) while also appropriately exhibit the response performance of the rear wheel steering.

Regarding the delay in the yaw rate during slalom traveling (traveling in which the reverse operation of the front wheel steering of the vehicle 12 is performed at the predetermined speed or higher), during fast slalom traveling, the vehicle 12 is significantly turned right and left. Therefore, it can be said that when the input of the steering wheel 22 is too fast, there is no advantage of enhancing yaw response at the rear wheel 20. Therefore, when the steering wheel 22 is turned at a speed higher than a certain speed, a current position is maintained until a target angle of the rear wheel 20 coincides with an actual rear wheel angle. That is, the correction unit 28c maximizes the limit on the control speed of the rear wheel steering actuator 24 and temporarily stops the rear wheel steering control.

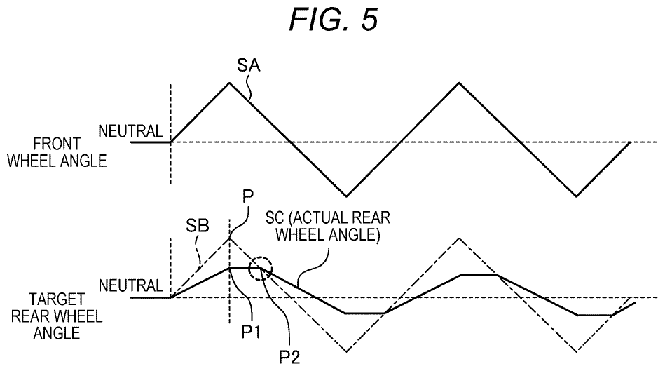

Here, a case is considered where the operation noise prevention is emphasized and the control speed of the rear wheel 20 is limited during the slalom traveling. In this case, as illustrated in FIG. 5, when a front wheel angle SA of the front wheel 18 based on the steering of the steering wheel 22 during the slalom traveling is reversed (for example, from left to right), a delay occurs on the rear wheel 20 side. For example, an actual rear wheel angle SC (delayed target rear wheel angle) is obtained with respect to a target rear wheel angle SB at the time when there is no delay for the front wheel angle SA and the limit on the control speed. In this case, the rear wheel 20 continues to be turned further to a left direction until the rear wheel 20 reaches the target rear wheel angle SB while maintaining the target rear wheel angle SB (for example, left) at the time when the front wheel 18 is steered to the left, causing the delay in the yaw rate.

Therefore, for example, when the steering angle sensor 26d or the like detects the slalom traveling (point P in the drawing), that is, when the steering angle sensor 26d or the like detects quick turning, the correction unit 28c generates a switching signal for switching to a control for correcting the limit on the control speed of the rear wheel steering actuator 24 to the maximum (for example, control speed=0), and maintains a current rear wheel angle (point P1 or later in the drawing). That is, the rear wheel 20 is stopped to be turned further to the left direction. As a result, an increase in the yaw rate in a direction opposite to the direction of the front wheel 18 can be prevented. The correction unit 28c corrects the limit on the control speed of the rear wheel steering actuator 24 to the maximum (switches to the operation noise prevention priority control), thereby preventing the generation of the operation noise.

Next, when the target rear wheel angle SB coincides with the actual rear wheel angle SC (point P2 in the drawing), that is, when the target rear wheel angle SB returns to a position of the actual rear wheel angle SC after the steering wheel 22 is steered in an opposite direction, the correction unit 28c resumes a control for the rear wheel steering actuator 24 to resume the control for the rear wheel 20. As a result, an increase in the yaw rate in a direction opposite to the direction of the front wheel 18 can be prevented.

In this way, in a configuration in which the control speed of the rear wheel steering actuator 24 is corrected, when the slalom traveling is performed, deviation from an ideal traveling line, which may occur due to the delay in the yaw rate, can be reduced, and appropriate response performance of the vehicle 12 can be acquired. At this time, the control speed of the rear wheel steering actuator 24 temporarily becomes zero, thereby preventing the generation of the operation noise. As a result, it is able to contribute to reducing the uncomfortable feeling due to the operation noise.

As described above, according to the embodiment disclosed here, the rear wheel steering apparatus 10 includes: the rear wheel steering mechanism 16 configured to set the control speed of the rear wheel steering actuator 24 in accordance with the vehicle speed of the vehicle 12; the acquisition unit 28a configured to acquire the traveling operation input information of the vehicle 12; the correction unit 28c configured to correct the control speed based on the traveling operation input information; and the drive control unit 28d configured to drive the rear wheel steering actuator 24 based on the correction result of correction by the correction unit 28c obtained by switching between a case where the control speed is limited and a case where the control speed is not limited. According to this configuration, for example, the control speed of the rear wheel steering actuator 24 can be corrected in accordance with a traveling operation (the traveling operation input information) of the vehicle 12, and the switching (distinction) between the case where the control speed is limited and the case where the control speed is not limited can be performed with good balance. Therefore, the control for prioritizing the operation noise prevention and the control for prioritizing the performance, according to a traveling operation state, can be performed with good balance.

In the above embodiment, the acquisition unit 28a may acquire the steering speed information of the front wheel steering of the vehicle 12 or the acceleration or deceleration information of the vehicle 12 as the traveling operation input information. According to this configuration, the switching (distinction) between the case where the control speed is limited and the case where the control speed is not limited can be performed with good balance in response to a behavior change such as rapid steering of the vehicle 12 or a behavior change such as quick acceleration or quick deceleration of the vehicle 12.

In the above embodiment, the acquisition unit 28a may acquire the steering direction information of the front wheel steering of the vehicle 12 as the traveling operation input information, and the correction unit 28c may not limit the control speed when the steering direction information indicates steering to a neutral steering direction, and limit the control speed when the steering direction information indicates steering to a non-neutral steering direction. According to this configuration, the switching (distinction) between the case where the control speed is limited and the case where the control speed is not limited can be performed with good balance in response to a behavior change at the time when the vehicle 12 is returned to the straight traveling state from the turning state.

In the above embodiment, the acquisition unit 28a may acquire, as the traveling operation input information, the reverse operation information indicating that the reverse operation of the front wheel steering of the vehicle 12 is performed at the predetermined speed or higher, and when the reverse operation information is acquired, the correction unit 28c may maximize the limit on the control speed until a target steering angle of the rear wheel 20 obtained by the rear wheel steering coincides with an actual steering angle of the rear wheel 20. According to this configuration, in the configuration in which the control speed of the rear wheel steering actuator 24 is corrected, when the slalom traveling is performed, the deviation from the ideal traveling line, which may occur due to the delay in the yaw rate, can be reduced.

The correction unit 28c may set the control speed in the first step and the second step when setting the control speed based on the traveling operation input information. In the first step, the control speed set, based on the vehicle speed of the vehicle 12, in the map in which the operation noise prevention is emphasized is compared with the control speed set in the control speed variable map based on the steering angle during traveling, and the larger control speed is adopted. In the second step, the control speed adopted in the first step is compared with the control speed set, based on the vehicle speed of the vehicle 12, in the map in which the performance is emphasized, and the smaller value is adopted to determine the control speed of the rear wheel steering actuator 24 based on the current traveling operation input information of the vehicle 12. According to this configuration, an appropriate control speed of the rear wheel steering actuator 24 can be easily determined.

In FIG. 4, an example is illustrated in which the correction unit 28c generates the switching signal instructing the switching between the operation noise prevention priority control and the performance priority control, and the drive control unit 28d performs the control switching processing of the rear wheel steering actuator 24 based on the switching signal. In another embodiment, the drive control unit 28d may acquire, from the correction unit 28c, the correction result (a correction content), for example, the correction information necessary for switching the control that is acquired with reference to various control maps stored in the storage unit 30. Then, the drive control unit 28d may generate a control switching signal based on the acquired correction information and determine whether to perform the control by the operation noise prevention priority control or the performance priority control, thereby obtaining the same effect.

FIG. 1 illustrates an example in which the rear wheel steering actuator 24 includes the motor M, the planetary gears G, and the like, but the configuration of the rear wheel steering actuator 24 is not limited thereto. For example, the motor M and a belt may be combined, and the same effect can be obtained.

According to an aspect of this disclosure, for example, the control speed of the rear wheel steering actuator can be corrected in accordance with a traveling operation (the traveling operation input information) of the vehicle, and switching (distinction) between the case where the control speed is limited and the case where the control speed is not limited can be performed with good balance.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A rear wheel steering apparatus comprising:
a rear wheel steering mechanism configured to set a control speed of a rear wheel steering actuator in accordance with a vehicle speed of a vehicle;
an acquisition unit configured to acquire traveling operation input information of the vehicle;
a correction unit configured to correct the control speed based on the traveling operation input information; and
a drive control unit configured to drive the rear wheel steering actuator based on a correction result of correction by the correction unit obtained by switching between a case where the control speed is limited and a case where the control speed is not limited.

2. The rear wheel steering apparatus according to claim 1, wherein
the acquisition unit is configured to acquire steering speed information of front wheel steering of the vehicle or acceleration or deceleration information of the vehicle as the traveling operation input information.

3. The rear wheel steering apparatus according to claim 1, wherein
the acquisition unit is configured to acquire steering direction information of front wheel steering of the vehicle as the traveling operation input information, and
the correction unit is configured to not limit the control speed when the steering direction information indicates steering to a neutral steering direction, and to limit the control speed when the steering direction information indicates steering to a non-neutral steering direction.

4. The rear wheel steering apparatus according to claim 1, wherein
the acquisition unit is configured to acquire, as the traveling operation input information, reverse operation information indicating that a reverse operation of front wheel steering of the vehicle is performed at a predetermined speed or higher, and
the correction unit is configured to, when the reverse operation information is acquired, maximize a limit on the control speed until a target steering angle of a rear wheel obtained by rear wheel steering coincides with an actual steering angle of the rear wheel.
